(19) United States
(12) Patent Application Publication
(10) Pub. No.: US 2010/0123846 A1
(43) Pub. Date: May 20, 2010

(54) DISPLAY SUBSTRATE AND DISPLAY DEVICE HAVING THE SAME

(76) Inventors: Young-Kwang Kim, Suwon-si (KR); Hyun-Uk Oh, Seongnam-si (KR)

Correspondence Address: F. CHAU & ASSOCIATES, LLC, 130 WOODBURY ROAD, WOODBURY, NY, 11797, US

(21) Appl. No.: 12/607,454

(22) Filed: Oct. 28, 2009

(30) Foreign Application Priority Data
Nov. 18, 2008 (KR) 2008-0114557

(51) Int. Cl. G02F 1/1343; G02F 1/1368

(52) U.S. Cl. 349/46; 349/147

(57) ABSTRACT

A display substrate includes a pixel, a first pad part and a second pad part. The pixel is disposed in a display area and includes a switching element connected to a gate line and a data line and a pixel electrode electrically connected to the switching element. The first pad part is disposed in a peripheral area outside the display area. The first pad part includes a first pad having a first conductive pattern formed from a first conductive layer, a second conductive pattern overlapped with the first conductive pattern and formed from a second conductive layer and an insulation layer disposed between the first and second conductive patterns. The second pad part is disposed in the peripheral area. The second pad part includes a second pad having a third conductive pattern connected to the first conductive pattern of the first pad.

### CROSS-REFERENCE TO RELATED APPLICATION

This application claims priority under 35 U.S.C. §119 to Korean Patent Application No. 2008-114557, filed on Nov. 18, 2008 in the Korean Intellectual Property Office (KIPO), the disclosure of which is incorporated by reference herein in its entirety.

### BACKGROUND OF THE INVENTION

1. Technical Field

The present invention relates to a display substrate and a display device having the display substrate. More particularly, the present invention relates to a display substrate for use in a liquid crystal display (LCD) device and an LCD device having the display substrate.

2. Discussion of the Related Art

In general, a liquid crystal display (LCD) device includes an LCD panel and a driving apparatus for driving the LCD panel. The LCD panel includes an array substrate, an opposite substrate facing the array substrate, and a liquid crystal layer interposed between the array substrate and the opposite substrate.

The array substrate includes a plurality of gate lines, a plurality of data lines, and a plurality of thin-film transistors (TFTs) electrically connected to a gate line and a data line, respectively. When the array substrate includes a pattern of a high metal density formed by a high-integrated technology such as an amorphous silicon gate (ASG) technology, a chip on glass (COG) technology, etc., the array substrate may be more susceptible to defects caused by static electricity. A reduction in these defects can be realized by making use of a technology for discharging static electricity.

For example, when a static electricity discharge device is employed in an LCD device such as a cellular phone, a personal digital assistant (PDA), etc., no defects may be generated at a static electricity of about ±4 kV when the LCD device is in a driving mode, and no defects may be generated at a static electricity of about ±8 kV when the LCD device is in a stand-by mode. When a device for discharging static electricity is not employed in the LCD device, defects due to static electricity may be generated in elements of the LCD device such as driving circuits, metal lines, transistors, etc.

Accordingly, there is a need to prevent defects in a display device caused by static electricity.

### SUMMARY OF THE INVENTION

According to an exemplary embodiment of the present invention, a display substrate includes a pixel, a first pad part and a second pad part. The pixel is disposed in a display area. The pixel includes a switching element connected to a gate line and a data line and a pixel electrode electrically connected to the switching element. The first pad part is disposed in a peripheral area outside the display area. The first pad part includes a first pad having a first conductive pattern formed from a first conductive layer, a second conductive pattern overlapped with the first conductive pattern and formed from a second conductive layer and an insulation layer disposed between the first and second conductive patterns. The second pad part is disposed in the peripheral area. The second pad part includes a second pad having a third conductive pattern connected to the first conductive pattern of the first pad.

The switching element includes a gate electrode formed from the first conductive layer, a source electrode formed from the second conductive layer and a drain electrode formed from the second conductive layer.

The first pad further includes a first pad pattern formed from the same conductive layer as the pixel electrode and electrically connected to the second conductive pattern, and the second pad further includes a second pad pattern formed from the same conductive layer as the pixel electrode and electrically connected to the third conductive pattern.

The first pad part is disposed at a periphery of the display substrate, and the first pad is disposed at a periphery of the first pad part.

The second pad part is disposed adjacent to the first pad part and is electrically connected to the data line.

A voltage applied to the first conductive pattern of the first pad is different from a voltage applied to the second conductive pattern of the first pad.

The first conductive pattern receives a common voltage, and the second conductive pattern receives a ground voltage.

The display substrate further includes a voltage line disposed at the peripheral area, wherein the voltage line is electrically connected to the second pad and is extended in parallel with the data line.

The display substrate further includes a static electricity capacitor including: a first electrode connected to the first conductive pattern of the first pad and extended to an area where an end portion of the voltage line is disposed; a second electrode overlapped with the first electrode and connected to the end portion of the voltage line, wherein the second electrode is extended to an area where the first pad is disposed; and the insulation layer disposed between the first and second electrodes.

The display substrate further includes a static electricity capacitor, wherein the static electricity capacitor is defined by the first conductive pattern of the first pad, the second conductive pattern of the first pad and the insulation layer disposed between the first and second conductive patterns.

According to an exemplary embodiment of the present invention, a display device includes a display panel, a printed circuit board (PCB) and a driving circuit part. The display panel includes a pixel, a first pad part and a second pad part. The pixel is disposed in a display area. The pixel includes a switching element connected to a gate line and a data line and a pixel electrode electrically connected to the switching element. The first pad part is disposed in a peripheral area outside the display area. The first pad part includes a first pad having a first conductive pattern formed from a first conductive layer, a second conductive pattern overlapped with the first conductive pattern and formed from a second conductive layer and an insulation layer disposed between the first and second conductive patterns. The second pad part is disposed in the peripheral area. The second pad part includes a second pad having a third conductive pattern connected to the first conductive pattern of the first pad. The PCB is electrically connected to the first pad part. The PCB has a ground part electrically connected to the second conductive pattern. The driving circuit part is electrically connected to the second pad part. The driving circuit part applies a common voltage to the third conductive pattern connected to the first conductive pattern through the second pad pattern.

The switching element includes a gate electrode formed from the same conductive layer as the first and third conductive patterns, and a source electrode and a drain electrode formed from the same conductive layer as the second conductive pattern.

The first pad part is disposed at a periphery of the display panel, and the first pad is disposed at a periphery of the first pad part.

The second pad part is electrically connected to the data line and is disposed adjacent to the first pad part.

The display device further includes a voltage line disposed at the peripheral area, wherein the voltage line is electrically connected to the second pad and is extended in parallel with the data line.

The display device further includes a static electricity capacitor including: a first electrode connected to the first conductive pattern of the first pad and extended to an area where an end portion of the voltage line is disposed; a second electrode overlapped with the first electrode and connected to the end portion of the voltage line, wherein the second electrode is extended to an area where the first pad is disposed; and the insulation layer disposed between the first and second electrodes.

The display device further includes a static electricity capacitor, wherein the static electricity capacitor is defined by the first conductive pattern of the first pad, the second conductive pattern of the first pad and the insulation layer disposed between the first and second conductive patterns.

According to an exemplary embodiment of the present invention, a display substrate, includes: a display area; and a peripheral area outside the display area, wherein the peripheral area comprises: a first pad that electrically connects to a printed circuit board of a display device, wherein the first pad includes a first conductive pattern and a second conductive pattern overlapping the first conductive pattern with an insulating layer therebetween; and a second pad adjacent to the first pad that electrically connects to a driving circuit part of the display device, wherein the second pad includes a third conductive pattern connected to the first conductive pattern.

A capacitor is formed in the overlapped area.

The first and third conductive patterns are formed from the same conductive layer.

### BRIEF DESCRIPTION OF THE DRAWINGS

The above and other features of the present invention will become more apparent by describing in detail exemplary embodiments thereof with reference to the accompanying drawings, in which:

FIG. 1 is a plan view of a display device according to an exemplary embodiment of the present invention;

FIG. 2 is a partially enlarged view of the display device in FIG. 1;

FIG. 3 is a cross-sectional view of a display panel corresponding to a pixel area in which a pixel is disposed according to an exemplary embodiment of the present invention;

FIG. 4 is a cross-sectional view of the display device taken along line I-I′ of FIG. 2;

FIG. 5 is a plan view of a display device according to an exemplary embodiment of the present invention;

FIG. 6 is a partially enlarged view of the display device in FIG. 5; and

FIG. 7 is a cross-sectional view of the display device taken along line II-IP of FIG. 6.

### DETAILED DESCRIPTION OF EXEMPLARY EMBODIMENTS

Exemplary embodiments of the present invention are described more fully hereinafter with reference to the accompanying drawings. The present invention may, however, be embodied in many different forms and should not be construed as limited to the exemplary embodiments set forth herein.

In the drawings, the sizes of layers and regions may be exaggerated for clarity. It will be understood that when an element or layer is referred to as being “on”, “connected to” or “coupled to” another element or layer, it can be directly on, connected or coupled to the other element or layer or intervening elements or layers may be present.

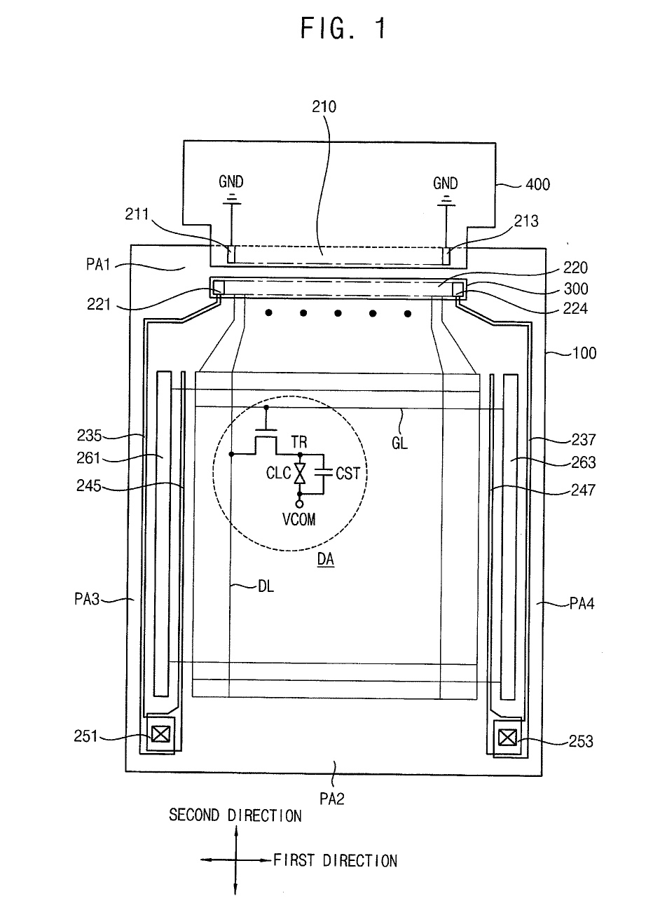

FIG. 1 is a plan view of a display device according to an exemplary embodiment of the present invention.

Referring to FIG. 1, the display device includes a display panel 100, a driving circuit part 300 and a printed circuit board (PCB) 400.

The display panel 100 includes a display substrate having a switching element TR arranged thereon, an opposite substrate facing the display substrate and a liquid crystal layer interposed between the display substrate and the opposite substrate. The display panel 100 includes a display area DA, a first peripheral area PA1, a second peripheral area PA2, a third peripheral area PA3 and a fourth peripheral area PA4. The first to fourth peripheral areas PA1, PA2, PA3 and PA4 surround the display area DA.

A plurality of gate lines GL, a plurality of data lines DL and a plurality of pixels P electrically connected to the gate lines GL and the data lines DL are disposed on the display area DA. The gate lines GL are extended in a first direction, and the data lines DL are extended in a second direction crossing the first direction. Each of the pixels P includes a switching element TR connected to the gate line GL and the data line DL, a liquid crystal capacitor CLC connected to the switching element TR and a storage capacitor CST connected to the switching element TR. A common voltage VCOM may be applied to the liquid crystal capacitor CLC and the storage capacitor CST.

A first pad part 210 and a second pad part 220 are disposed at the first peripheral area PA1. The first pad part 210 includes a plurality of pads electrically connected to the PCB 400. The PCB 400 may include a flexible PCB (FPCB). The first pad part 210 includes first pads 211 and 213 receiving the common voltage VCOM. The first pads 211 and 213 may be disposed at a periphery of the first pad part 210 and have a larger area than other pads. Hereinafter, the first pad will be referred as an input pad.

The second pad part 220 includes a plurality of pads electrically connected to the driving circuit part 300 and a plurality of pads electrically connected to the data lines DL. The second pad part 220 includes second pads 221 and 224 electrically connected to the input pads 211 and 213. The second pads 221 and 224 may be disposed at a periphery of the second pad part 220. Hereinafter, the second pad will be referred as an output pad.

The PCB 400 is electrically connected to the first pad part 210. A ground part GND is disposed at the PCB 400. The input pads 211 and 213 are electrically connected to the ground part GND.

The driving circuit part 300 may be formed of the chip type. A terminal of the driving circuit part 300, which outputs the common voltage VCOM, is electrically connected to the output pads 221 and 224 of the second pad part 220. The output pads 221 and 224 are electrically connected to the input pads 211 and 213.

A first short point 251 and a second short point 253 are formed in the second peripheral area PA2. The first and second short points 251 and 253 are shorted to a common electrode layer of the opposite substrate to provide the common voltage VCOM to the common electrode layer of the opposite substrate. The common electrode layer corresponds to a common electrode of the liquid crystal capacitor CLC.

A first voltage line 235, a second voltage line 245 and a first gate circuit part 261 are formed at the third peripheral area PA3. The first voltage line 235 is electrically connected to the output pad 221 of the second pad part 220 and extended in the second direction, so that the first voltage line 235 is electrically connected to the first short point 251. The second voltage line 245 is electrically connected to the first short point 251 and extended in the second direction, and the second voltage line 245 is electrically connected to a storage line (not shown) formed at the display area DA. The second voltage line 245 transmits the common voltage VCOM that is applied to a storage capacitor CST of the pixel P.

The first gate circuit part 261 sequentially outputs a plurality of gate signals to gate lines of a first group among the gate lines GL. For example, the first group may be odd numbered gate lines.

A third voltage line 237, a fourth voltage line 247 and a second gate circuit part 263 are formed at the fourth peripheral area PA4. The third voltage line 237 is electrically connected to the output pad 224 of the second pad part 220 and extended in the second direction, so that the third voltage line 237 is electrically connected to the second short point 253. The fourth voltage line 247 is electrically connected to the second short point 253 and extended in the second direction, so that the fourth voltage line 247 is electrically connected to the storage line (not shown) formed at the display area DA. The fourth voltage line 247 transmits the common voltage VCOM applied to the storage capacitor CST of the pixel P.

The second gate circuit part 263 sequentially outputs a plurality of gate signals to gate lines of a second group among the gate lines GL. For example, the second group may be even numbered gate lines.

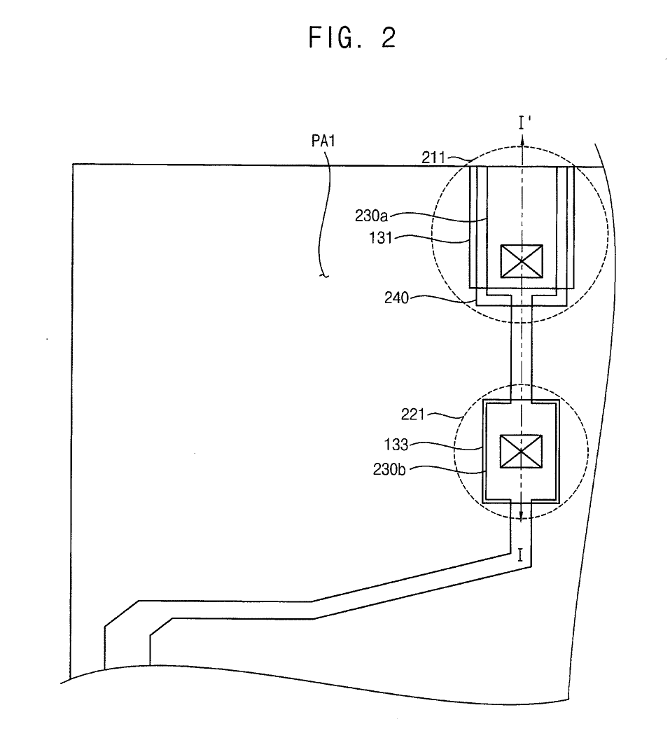

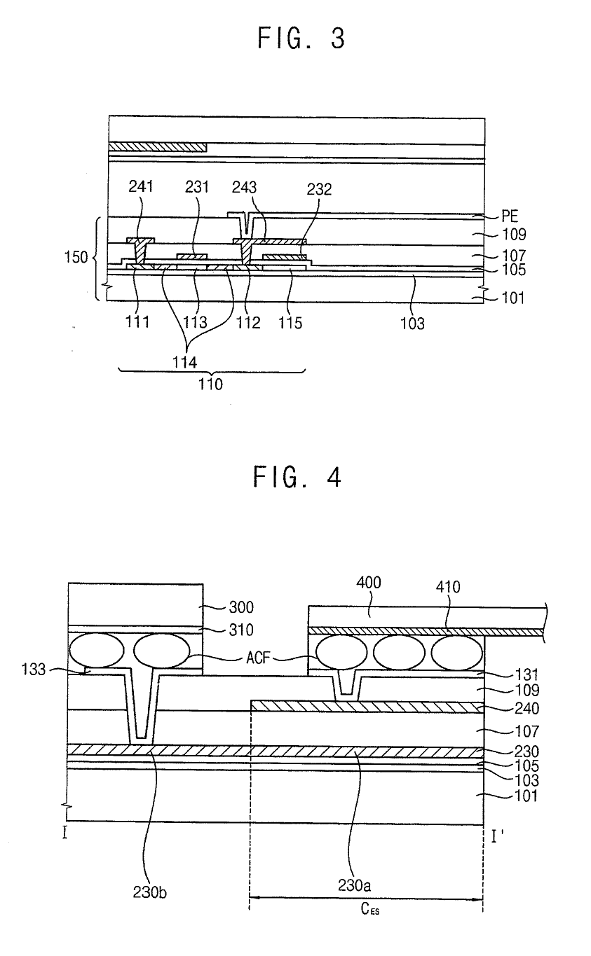

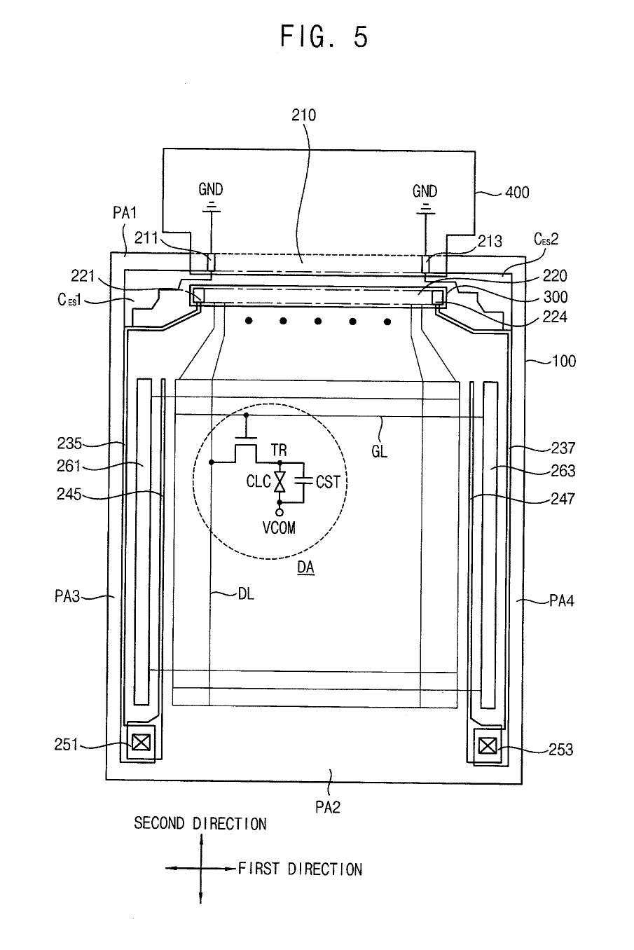

FIG. 2 is a partially enlarged view of the display device in FIG. 1. FIG. 3 is a cross-sectional view of a display panel corresponding to a pixel area in which a pixel is disposed according to an exemplary embodiment of the present invention. FIG. 4 is a cross-sectional view of the display device taken along line I-I′ of FIG. 2.

Referring to FIGS. 1 to 4, a switching element TR, a storage capacitor CST and a pixel electrode PE are disposed on a pixel area of the display substrate 150. A blocking layer 103, a gate insulation layer 105, an insulation interlayer 107 and an upper insulation layer 109 are disposed on the pixel area.

For example, the blocking layer 103 is formed on a first base substrate 101 to make contact with the first base substrate 101. The switching element TR includes a poly-crystallized silicon layer 110 formed on the blocking layer 103. The poly-crystallized silicon layer 110 includes a source area 111, a drain area 112, a channel area 113 and a low density area 114. The source area 111 is an area which makes contact with a source electrode 241 of the switching element TR, and the low density area 114 is an area into which dopants of low concentration are doped. The channel area 113 is an area into which dopants of higher concentration than the dopants of the low density area 114 are doped. Moreover, the poly-crystallized silicon layer 110 includes a first storage electrode 115 into which dopants of high concentration identical to the dopants of the channel area 113 are doped.

The switching element TR includes a gate electrode 231, a source electrode 241 and a drain electrode 243. The gate electrode 231 is formed from a first conductive layer in correspondence with the channel area 113 of the poly-crystallized silicon layer 110. The source and drain electrodes 241 and 243 are formed from a second conductive layer to make contact with the source and drain areas 111 and 112 of the poly-crystallized silicon layer 110, respectively.

A second storage electrode 232 formed from the first conductive layer is disposed on the first storage electrode 115, and the drain electrode 243 is extended to overlap with the second storage electrode 232.

The pixel electrode PE is formed from a third conductive layer with an optically transparent property. The pixel electrode PE makes direct contact with the drain electrode 243 and is formed at the pixel area.

The gate insulation layer 105 is disposed between the blocking layer 103 and the gate electrode 231 formed from the first conductive layer. The gate insulation layer 105 may include a double layered structure. For example, the gate insulation layer 105 may include a silicon nitride (SiNx) layer and a silicon oxide (SiO₂) layer. The insulation interlayer 107 is disposed between the gate electrode 231 formed from the first conductive layer and the source and drain electrodes 241 and 243 formed from the second conductive layer. The upper insulation layer 109 is disposed between the source and drain electrodes 241 and 243 formed from the second conductive layer and the pixel electrode PE formed from the third conductive layer.

As described above, a channel area of a switching element is formed by using a poly-crystallized silicon layer. Alternatively, the channel area of the switching element may be formed by using an amorphous silicon layer. When the amorphous silicon layer is used to form the channel area of the switching element, the first storage electrode may be formed from a conductive layer identical to a gate electrode of the switching element.

The input pad 211 and the output pad 221 are disposed at the first peripheral area PA1 of the display substrate.

The input pad 211 includes a first conductive pattern 230a formed from the first conductive layer, the insulation interlayer 107, the second conductive pattern 240 formed from the second conductive layer, the upper insulation layer 109 and a first pad pattern 131 formed from the third conductive layer and electrically connected to the second conductive pattern 240. The input pad 211 may be electrically connected to a ground pattern 410 formed at the PCB 400 through an anisotropic conductive film (ACF). The ground pattern 410 is electrically connected to a ground portion GND of the PCB 400 to have a ground voltage.

The output pad 221 includes a third conductive pattern 230b connected to the first conductive pattern 230a and a second pad pattern 133 electrically attached to the third conductive pattern 230b. The first and third conductive patterns 230a and 230b may be formed from the first conductive layer. The output pad 221 may be electrically attached to a terminal 310 of the driving circuit part 300 through the ACF. The terminal 310 of the driving circuit part 300 outputs the common voltage VCOM. The common voltage VCOM is applied to the third conductive pattern 230b through the second pad pattern 133.

As a result, a static electricity capacitor C_{ES} is defined at an area in which the input pad 211 is formed. The common voltage VCOM is applied to the first conductive pattern 230a of the input pad 211, and the ground voltage is applied to the second conductive pattern 240 of the input pad 211. Thus, the static electricity capacitor C_{ES} may be defined by the first conductive pattern 230a, the second conductive pattern 240 and the insulation interlayer 107 disposed between the first and second conductive patterns 230a and 240.

As a plural number of the input pads 211 and 213 are formed at two edge portions of the first pad part 210, a capacitance of the static electricity capacitor C_{ES} may be increased. For example, when the input pad 211 has a width of about 80 μm and a length of about 760 μm, the gate insulation layer 105 has a silicon nitride layer with a permittivity of about 6.6∈₀ and a thickness of about 6000 Å and a silicon oxide layer with a permittivity of about 6.6∈₀ and a thickness of about 1500 Å, and a permittivity of the gate insulation layer 105 is about 5.5∈₀, a capacitance Cap of one input pad 211 may be defined by the following Equation 1.

$$\begin{matrix}𝒞 = 5.5 \times {ɛ}_{0} \times \frac{A}{d} \\ = 5.5 \times 8.854 \times {10}^{- 12} F \text{/} m \times \frac{( 80 µm \times 760 µm )}{7500 Å} \\ = 29.61 nF\end{matrix} \qquad Equation 1$$

In Equation 1, ‘∈₀’ is an electrical permittivity of free space, ‘A’ is a square and is a thickness of a dielectric layer. When five input pads are formed at two end portions of the first pad part 210, respectively, a static electricity capacitance formed at the first pad part 210 may be about 296 nF in accordance with Equation 1.

The static electricity capacitor C_{ES} is formed by using the first pad part 210 disposed at a periphery of the display panel 100, so that it prevents static electricity from infiltrating the display panel 100. Therefore, defects in the driving circuit part 300 and the gate and data lines GL and DL, etc., which are caused by static electricity, may be prevented.

FIG. 5 is a plan view of a display device according to an exemplary embodiment of the present invention.

The display device according to the present exemplary embodiment is substantially the same as the display device according to the exemplary embodiment shown in FIGS. 1 to 4, except for a static electricity capacitance C_{ES}. Thus, the same reference numerals will be used to refer to the same or like parts and any further description thereof will be limited.

Referring to FIG. 5, the display substrate includes a display area DA, a first peripheral area PA1, a second peripheral area PA2, a third peripheral area PA3 and a fourth peripheral area PA4. The first to fourth peripheral areas PA1, PA2, PA3 and PA4 are surrounding the display area DA.

A first pad part 210, a first static electricity capacitor C_{ES}1, a second static electricity capacitor C_{ES}2 and a second pad part 220 are disposed on the first peripheral area PA1. The first pad part 210 includes a plurality of pads electrically connected to the PCB 400. The first pad part 210 includes input pads 211 and 213 receiving the common voltage VCOM. The input pads 211 and 213 may be disposed at two end portions to have a larger area than other pads.

The first static electricity capacitor C_{ES}1 is extended from a first end portion of the first pad part 210 to a first end portion of the first voltage line 235 extended along the second direction. The first static electricity capacitor C_{ES}1 may be formed within an extendable area of the first peripheral area PA1. For example, an area of the first static electricity capacitor C_{ES}1 may be extended a few μm² to about 10 μm².

The second static electricity capacitor C_{ES}2 is extended from a second end portion of the first pad part 210 to a first end portion of a third voltage line 237 extended along the second direction. The second static electricity capacitor C_{ES}2 may be formed within an extendable area of the first peripheral area PA1. For example, an area of the second static electricity capacitor C_{ES}2 may be extended a few μm² to about 10 μm².

The PCB 400 is electrically connected to the first pad part 210. The PCB 400 has a ground portion GND disposed thereon. The input pads 211 and 213 are electrically connected to the ground portion GND. A ground voltage of the ground portion GND is applied to second electrodes of the first and second static electricity capacitors C_{ES}1 and C_{ES}2 through the input pads 211 and 213, respectively.

The second pad part 220 includes a plurality of pads electrically connected to the driving circuit part 300. The second pad part 220 includes output pads 221 and 224 electrically connected to the input pads 211 and 213, respectively. The output pads 221 and 224 may be disposed at two end terminals of the second pad part 220.

The driving circuit part 300 may be formed of the chip type. A terminal of the driving circuit part 300, which outputs the common voltage VCOM, is electrically connected to the output pads 221 and 224 of the second pad part 220. The output pads 221 and 224 are electrically connected to the input pads 211 and 213.

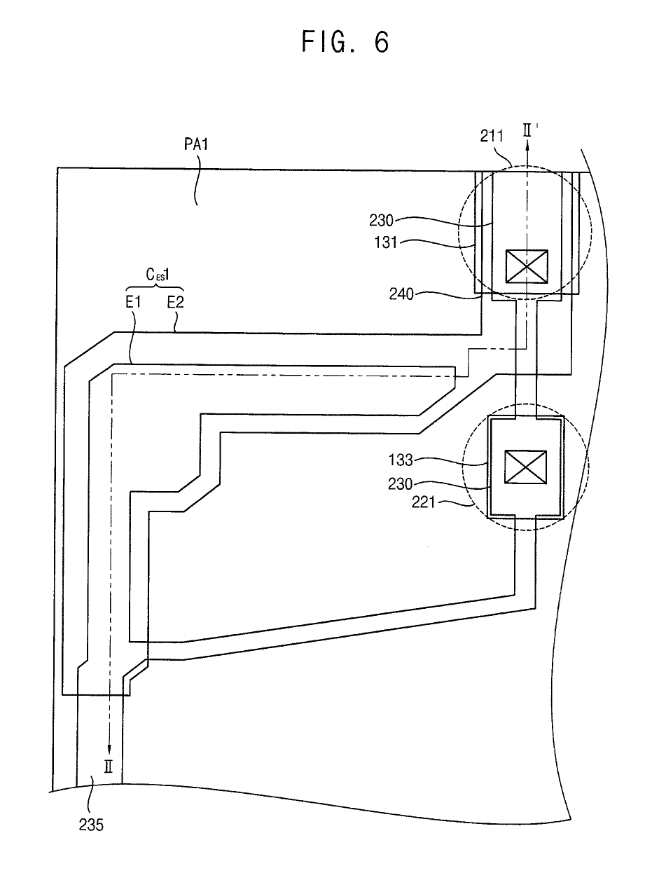

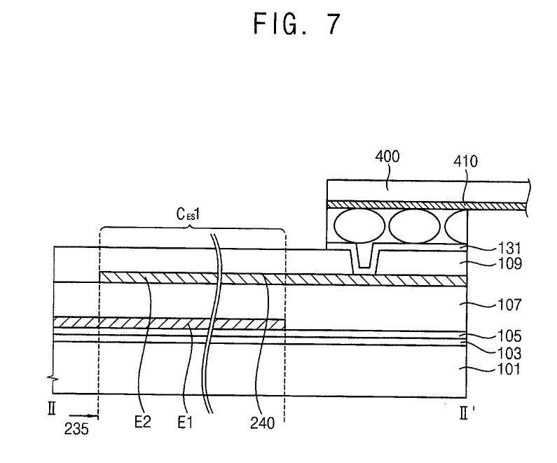

FIG. 6 is a partially enlarged view of the display device in FIG. 5. FIG. 7 is a cross-sectional view of the display device taken along line II-II′ of FIG. 6.

Referring to FIGS. 5 to 7, the input pad 211, the output pad 221 and a first static electricity capacitor C_{ES}1 are disposed at a peripheral area PA1 of the display substrate.

The input pad 211 includes a first conductive pattern 230 formed from the first conductive layer, the insulation interlayer 107, a second conductive pattern 240 formed from the second conductive layer, the upper insulation layer 109 and a first pad pattern 131 formed from a third conductive layer and electrically connected to the second conductive pattern 240. The input pad 211 is electrically connected to a ground pattern 410 formed at the PCB 400 through an ACF. The ground pattern 410 is electrically connected to the ground portion GND of the PCB 400 to have a ground voltage. In an area where the input pad 211 is formed, a static electricity capacitor C_{ES} may be defined by the first conductive pattern 230, the insulation interlayer 107 and the second conductive pattern 240.

The output pad 221 includes a second pad pattern 133 electrically connected to the first conductive pattern 230. The output pad 221 is electrically connected to a terminal 310 of the driving circuit part 300 through the ACF. The terminal 310 of the driving circuit part 300 outputs the common voltage VCOM. The common voltage VCOM is applied to the first conductive pattern 230 through the output pad 221.

The first static electricity capacitor C_{ES}1 may be defined by a first electrode E1 formed from the first conductive layer, a second electrode E2 formed from the second conductive layer, and the insulation interlayer 107 disposed between the first and second electrodes E1 and E2. The first electrode E1 is extended from a first end portion of the first voltage line 235 to a portion adjacent to the input pad 211 to receive the common voltage VCOM through the first voltage line 235. For example, the first electrode E1 is extended from the first voltage line 235, so that the first electrode E1 may be electrically connected to the first voltage line 235. In another example, the first electrode E1 makes direct contact with the first voltage line 235 through a contact hole, so that the first electrode E1 may be electrically connected to the first voltage line 235. The second electrode E2 is extended from the second conductive pattern 240 to a first end portion of the first voltage line 235 to receive the ground voltage through the input pad 211.

The first static electricity capacitor C_{ES}1 is formed within an extendable area of the first peripheral area PA1, so that a capacitance of the first static electricity capacitor C_{ES}1 may be increased. The first and second static electricity capacitors C_{ES}1 and C_{ES}2, which are formed at edge portions of the display panel 100, may prevent static electricity from infiltrating the display panel 100. Thus, defects in the driving circuit part 300 and the gate and data lines GL and DL, etc., which are caused by static electricity, may be prevented.

Therefore, since the display device of the present exemplary embodiment can increase the size and thus the capacitance of a static electricity capacitor, the display device of the present exemplary embodiment may prevent more defects due to static electricity than the display device of the exemplary embodiment shown in FIGS. 1 to 4.

According to exemplary embodiments of the present invention, a pad part, which is electrically connected to a PCB, is formed to include first and second conductive patterns that receive voltages different from each other, so that the pad part may be used as a static electricity capacitor for blocking an inflow of static electricity. Therefore, by using the static electricity capacitor in a display device, defects in the display device due to static electricity may be prevented. Moreover, since the static electricity capacitor may be formed to have a large size within an extendable area of a peripheral area of a display panel, the static electricity capacitor's ability to block static electricity may be enhanced.

While the present invention has been described in detail with reference to the exemplary embodiments, those skilled in the art will appreciate that various modifications and substitutions can be made thereto without departing from the spirit and scope of the present invention as set forth in the appended claims.

What is claimed is:

1. A display substrate, comprising:
a pixel disposed in a display area, wherein the pixel comprises a switching element connected to a gate line and a data line and a pixel electrode electrically connected to the switching element;
a first pad part disposed in a peripheral area outside the display area, wherein the first pad part comprises a first pad having a first conductive pattern formed from a first conductive layer, a second conductive pattern overlapped with the first conductive pattern and formed from a second conductive layer and an insulation layer disposed between the first and second conductive patterns; and
a second pad part disposed in the peripheral area, wherein the second pad part comprises a second pad having a third conductive pattern connected to the first conductive pattern of the first pad.

2. The display substrate of claim 1, wherein the switching element comprises a gate electrode formed from the first conductive layer, a source electrode formed from the second conductive layer and a drain electrode formed from the second conductive layer.

3. The display substrate of claim 1, wherein the first pad further comprises a first pad pattern formed from the same conductive layer as the pixel electrode and electrically connected to the second conductive pattern, and
the second pad further comprises a second pad pattern formed from the same conductive layer as the pixel electrode and electrically connected to the third conductive pattern.

4. The display substrate of claim 1, wherein the first pad part is disposed at a periphery of the display substrate, and the first pad is disposed at a periphery of the first pad part.

5. The display substrate of claim 4, wherein the second pad part is disposed adjacent to the first pad part and is electrically connected to the data line.

6. The display substrate of claim 1, wherein a voltage applied to the first conductive pattern of the first pad is different from a voltage applied to the second conductive pattern of the first pad.

7. The display substrate of claim 6, wherein the first conductive pattern receives a common voltage, and the second conductive pattern receives a ground voltage.

8. The display substrate of claim 7, further comprising:
a voltage line disposed at the peripheral area, wherein the voltage line is electrically connected to the second pad and is extended in parallel with the data line.

9. The display substrate of claim 1, further comprising:
a static electricity capacitor comprising:
a first electrode connected to the first conductive pattern of the first pad and extended to an area where an end portion of the voltage line is disposed;
a second electrode overlapped with the first electrode and connected to the end portion of the voltage line, wherein the second electrode is extended to an area where the first pad is disposed; and
the insulation layer disposed between the first and second electrodes.

10. The display substrate of claim 1, further comprising:
a static electricity capacitor, wherein the static electricity capacitor is defined by the first conductive pattern of the first pad, the second conductive pattern of the first pad and the insulation layer disposed between the first and second conductive patterns.

11. A display device, comprising:
a display panel comprising:
a pixel disposed in a display area, wherein the pixel comprises a switching element connected to a gate line and a data line and a pixel electrode electrically connected to the switching element;
a first pad part disposed in a peripheral area outside the display area, wherein the first pad part comprises a first pad having a first conductive pattern formed from a first conductive layer, a second conductive pattern overlapped with the first conductive pattern and formed from a second conductive layer and an insulation layer disposed between the first and second conductive patterns; and
a second pad part disposed in the peripheral area, wherein the second pad part comprises a second pad having a third conductive pattern connected to the first conductive pattern of the first pad;
a printed circuit board (PCB) electrically connected to the first pad part, wherein the PCB has a ground part electrically connected to the second conductive pattern; and
a driving circuit part electrically connected to the second pad part, wherein the driving circuit part applies a common voltage to the third conductive pattern connected to the first conductive pattern through a second pad pattern.

12. The display device of claim 11, wherein the switching element comprises a gate electrode formed from the same conductive layer as the first and third conductive patterns, and a source electrode and a drain electrode formed from the same conductive layer as the second conductive pattern.

13. The display device of claim 11, wherein the first pad part is disposed at a periphery of the display panel, and the first pad is disposed at a periphery of the first pad part.

14. The display device of claim 13, wherein the second pad part is electrically connected to the data line and is disposed adjacent to the first pad part.

15. The display device of claim 14, further comprising:
a voltage line disposed at the peripheral area, wherein the voltage line is electrically connected to the second pad and is extended in parallel with the data line.

16. The display device of claim 15, further comprising:
a static electricity capacitor comprising:
a first electrode connected to the first conductive pattern of the first pad and extended to an area where an end portion of the voltage line is disposed;
a second electrode overlapped with the first electrode and connected to the end portion of the voltage line, wherein the second electrode is extended to an area where the first pad is disposed; and
the insulation layer disposed between the first and second electrodes.

17. The display device of claim 11, further comprising:
a static electricity capacitor, wherein the static electricity capacitor is defined by the first conductive pattern of the first pad, the second conductive pattern of the first pad and the insulation layer disposed between the first and second conductive patterns.

18. A display substrate, comprising:
a display area; and
a peripheral area outside the display area, wherein the peripheral area comprises:
a first pad that electrically connects to a printed circuit board of a display device, wherein the first pad includes a first conductive pattern and a second conductive pattern overlapping the first conductive pattern with an insulating layer therebetween; and
a second pad adjacent to the first pad that electrically connects to a driving circuit part of the display device, wherein the second pad includes a third conductive pattern connected to the first conductive pattern.

19. The display substrate of claim 18, wherein a capacitor is formed in the overlapped area.

20. The display substrate of claim 18, wherein the first and third conductive patterns are formed from the same conductive layer.
